(19) United States
(12) Patent Application Publication
(10) Pub. No.: US 2023/0177225 A1
(43) Pub. Date: Jun. 8, 2023

(54) METHODS AND SYSTEMS OF OPERATIONS AND MAINTENANCE OF A PHYSICAL ASSETS

(71) Applicants: SWARUP RAMAPRIYA MAVANOOR, BENGALURU (IN); SAIDEEP TALARI, BENGALURU (IN); JAYA KRISHNAN NAIR, Bengaluru (IN)

(72) Inventors: SWARUP RAMAPRIYA MAVANOOR, BENGALURU (IN); SAIDEEP TALARI, BENGALURU (IN); JAYA KRISHNAN NAIR, Bengaluru (IN)

(21) Appl. No.: 17/541,051

(22) Filed: Dec. 2, 2021

(51) Int. Cl. G06F 30/13; G06F 30/20

(52) U.S. Cl. CPC G06F 30/13; G06F 30/20; G06Q 50/06

(57) ABSTRACT

A method of useful for digitizing a physical of assets includes the step of, with a processor of a mobile device, obtaining a set of information from an infrastructure of assets from the set of information. The method includes the step of generating a physical model of the infrastructure of assets. The physical model comprises a set of the vectors representing each of the individual physical elements within each asset. The method includes the step of generating a logical model of the infrastructure of assets. The logical model comprises a description of a connection between an element in the physical model to each other object of the physical model. The method includes the step of mapping each element of the logical model to at least one element of the physical model. The method includes the step of acquiring and attaching data to an element of the logical model to an element of the physical model. The method includes the step of creating a workflow and associating the workflow at least one element of the physical model or the logical model. The method includes the step of providing an infrastructure-asset information with a map-based interface. The infrastructure-asset information comprises information about each asset of the infrastructure of assets. The method includes the step of creating a set of views. The set of views is combined with any data associated with a relevant element of the physical model or logical model. The set of views is viewable via a computerized dashboard application.

### BACKGROUND

Solar power plant operations management is one of the least digitized globally. Solar operations still often relies on traditional methodologies. Potential operations and maintenance cost savings can be realized through digitalization of various manually performed tasks. Digital transformation of operations and maintenance (e.g. including thermography) can improve yield gains while significantly reducing the time required for such manual inspections. Digital transformation of operations and maintenance can also enable/enhance collaboration for internal and external teams. Scheduling and execution of preventive and corrective maintenance can be streamlined, enabling timely identification and rectification of issues that cause yield loss.

### SUMMARY OF THE INVENTION

A method for digitizing a physical assets that includes using a processor of a mobile device, obtaining a set of information from the assets. The method includes a step of generating a physical model of the infrastructure of assets. The physical model comprises a set of the vectors representing each of the individual physical elements within each asset. The method includes the step of generating a logical model of the infrastructure of assets. The logical model comprises a description of a connection between an element in the physical model to each other object of the physical model. The method includes the step of mapping each element of the logical model to at least one element of the physical model. The method includes the step of acquiring and attaching data to an element of the logical model from an element of the physical model. The method includes the step of creating a workflow and associating the workflow at least one element of the physical model or the logical model. The method includes the step of providing an infrastructure-asset information with a map or blue-print based interface. The infrastructure-asset information comprises information about each asset of the infrastructure of assets. The method includes the step of creating a set of views. The set of views is combined with any data associated with a relevant element of the physical model or logical model. The set of views is viewable via a computerized dashboard or mobile application.

### BRIEF DESCRIPTION OF THE DRAWINGS

The present application can be best understood with reference to the following description taken in conjunction with the accompanying figures, in which like parts may be referred to by like numerals.

FIG. 1 illustrates an example process for automatically mapping the physical topology of tracker controllers and tracker actuators to the logical topology in solar PV plants using UAVs, according to some embodiments.

FIG. 2 illustrates an example tracker system, according to some embodiments.

FIG. 3 illustrates an example process for mapping-related data processing, according to some embodiments.

FIG. 4 illustrates an example system for implementing mission planning while ensuring adequate coverage of target area during UAV image acquisition, according to some embodiments.

FIG. 5 illustrates an example polygon with breadth b and length I can be projected for a known camera at a known height, according to some embodiments.

FIG. 6 illustrates an example view of a planned mission and projected polygons on the ground, according to some embodiments.

FIG. 7 illustrates an additional path for low coverage areas, according to some embodiments.

FIG. 8 illustrates an example process for enhanced energy production (yield) from generating plants with bifacial solar PV modules using unmanned aerial vehicles, according to some embodiments.

FIG. 9 illustrates an example process for implementing a PSM, according to some embodiments.

FIG. 10 illustrates an example irradiance-optimizer process, according to some embodiments.

FIG. 11 illustrates an example process for developing a vectorized 3D as-built model for a PV plant, according to some embodiments.

FIG. 12 illustrates an example process for processing pipeline for 3D model generation, according to some embodiments.

FIG. 13 illustrates example views of point detectors, according to some embodiments.

FIG. 14 illustrates an example process for implementing an altitude extractor, according to some embodiments.

FIG. 15 illustrates an example process for implementing a RANSAC algorithm on each table, according to some embodiments.

FIG. 16 illustrates an example process for operations and maintenance of a photovoltaics system, according to some embodiments.

FIGS. 17-25 illustrate example operations and maintenance of a photovoltaics system interfaces, according to some embodiments.

FIG. 26 illustrates an example process for digitizing a physical infrastructure asset, according to some embodiments.

The Figures described above are a representative set and are not exhaustive with respect to embodying the invention.

### DESCRIPTION

Disclosed are a system, method, and article or manufacture for operations and maintenance of a physical of assets. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Albedo is the measure of the diffuse reflection of solar radiation out of the total solar radiation.

Bi-facial PV technology enables increase in solar PV system yields by providing for generation from both sides of a PV module.

Deep-learning algorithms can be based on a set of algorithms that attempt to model high-level abstractions in data by using multiple processing layers, with complex structures or otherwise, composed of multiple non-linear transformations.

Digital surface model (DSM) is 3D computer-graphics representation of a terrain’s surface used to digitally map topography.

Machine learning systems can use algorithms that can learn from and make predictions on data.

Photovoltaics (PV) is the conversion of light into electricity using semiconducting materials that exhibit the photovoltaic effect. A photovoltaic system employs solar panels, each comprising a number of solar cells, which generate electrical power. PV installations may be ground-mounted, rooftop mounted, or wall mounted. The mount may be fixed or use a solar tracker to follow the sun across the sky.

Physical asset can be, for example, physical embodiments/buildings/factories/roads/transmission lines/powerplants/cities and or any other type of infrastructure.

Random sample consensus (RANSAC) is an iterative method to estimate parameters of a mathematical model from a set of observed data that contains outliers, when outliers are to be accorded no influence on the values of the estimates.

Unmanned aerial vehicle (UAV) (e.g. a ‘drone’, etc.) is an aircraft without a human pilot onboard. UAVs can be a component of an unmanned aircraft system (UAS). The flight of UAVs may operate with various degrees of autonomy (e.g. under remote control by a human operator, autonomously by onboard computers, etc.).

### Exemplary Methods

Processes provided herein can digitize physical assets (PA). A system can have two parts/models that describe the constituents of the PA. A physical model can be a set of vectors representing individual elements w/in assets. Each element has location and set of properties (e.g. title, other data, etc.) The physical model can include documents of land asset is on, etc. The physical model can be n sub-divisions and groupings of physical assets, etc.

A logical model describes how assets in physical model are connected to each other. The logical model can describe at sub-component level (e.g. have a tracker with three strings, etc.). The logical model can be more than just connections as well. The logical model can be one or more logical elements for each physical element. With the two models, PA processes can acquire, store and process data that is attached to any element to each of these models. These can be of different data types, including: files, time series information, process information, agreements, component data sheets, warranties, legal, etc.

PA processes can provide the ability to create work items and associate it with any element in the physical or logical models. This can be a single task or a group of tasks, or a workflow of tasks, etc. For each work element, PA processes can assign/attach a user with access, responsible for work, files, diagrams and docs, images, etc. PA processes can attach freeform conversations attached to each work element (e.g. to physical model elements and logical model elements and/or any object within system or coming into the system). Work items can be cross referenced between physical and logical model. Tools for users (e.g. onsite) with ability to access this information with a map-based interface on a device (e.g. handheld, tablet, smart phone, etc.). Because elements have a location, PA processes can enable navigate on the interface to enable anyone using system to locate the component against which a work element is created. PA processes can connect with sensors and data systems and acquire sensor and performance data and connect to physical and logical model. PA processes can create views within each model and combine this with sensor and/or other data. This data can be containerized and passed on to another system as well.

PA processes can provide methods of digitizing information and creating the models. For example, a drone-based method can be used to map a PA and automatically create a physical model and map to a logical model. PA processes can automatically create an addressing system for individual elements on a site where there is a multitude of elements of the same type. For example, PA processes can automatically create a grid numbering systems that uniquely identifies every element of a site. PA site elements can use a multitude of names or addresses.

PA processes can provide the ability to use a plurality of 3D data image, elevation maps and point clouds to extract physical parameters of a constructed site. PA processes can extract features on a solar site using a neural network and build associations that describe logical connection between elements without user intervention. PA processes can use a bifacial model with the ability to create a performance model for each site based on system information and use performance model to optimize variables that enhance efficiency of operation. For example, PA processes can use this data to enhance each row and/or block solar tracking, etc. PA processes can estimate and quantify the enhance benefit of use of modules, trackers, etc. on a site. PA processes can provide the ability to use data and system models to create a unique simulateable performance of site and link to a forecasting system and/or electrical grid for forecasting production.

### Automatically Map the Physical Topology to the Logical Topology of Tracker Controllers and Tracker Actuators in a Tracker Based Solar PV Plant

PV solar tracker is a system that orients solar PV collectors toward the sun to minimize the angle of incidence between the incoming sunlight and a photovoltaic panel. Solar tracking systems consist of a mechanical structure for mounting PV panels along with a mechanism to rotate the surface plane of the PV panels along 1 or 2 axes. Additionally, each tracker includes a motor and drive to rotate the mechanism and a control system to drive each motor and set the angle of inclination of each tracker. All of the controllers in a single plant are networked to a central controller that manages the positioning of each individual tracker through the day. During commissioning of a plant, it is essential to develop an as-built physical topology that describes the connection between individual tracker drivers and controllers, to enable accurate and independent control of each tracker, and also to enable easy identification/rectification of defects that may be detected in the system.

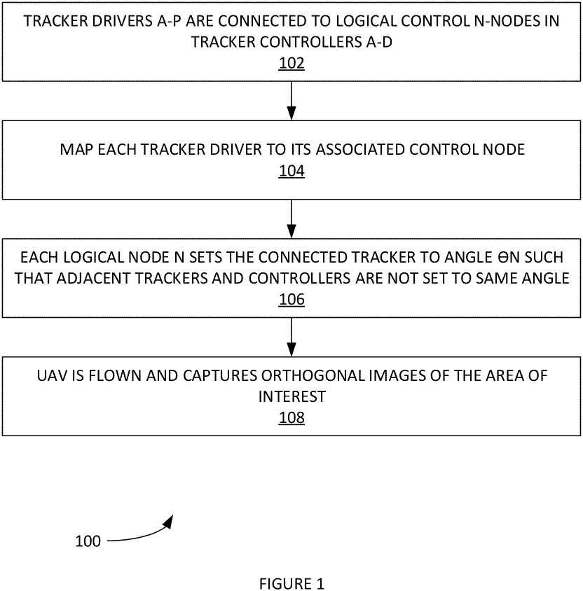

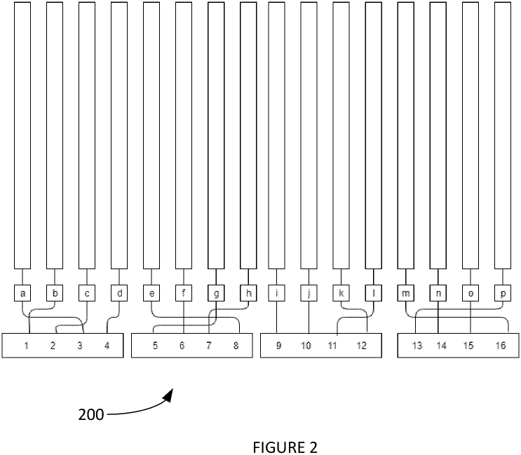

FIG. 1 illustrates an example process 100 for automatically mapping the physical topology of tracker controllers and tracker actuators to the logical topology in solar PV plants using UAVs, according to some embodiments. Process 100 uses a combination of tracker positioning and UAV based image acquisition to physical topology mapping.

In step 102, tracker drivers a-p are connected to logical control n-nodes (e.g. nodes 1-16 in FIG. 2 infra) in tracker controllers (e.g. tracker controllers A-D in FIG. 2 infra). In step 104 process 100 maps each tracker driver to its associated control node.

FIG. 2 illustrates an example tracker system 200, according to some embodiments. In this example, tracker driver A is connected to logical node 3 and driver G is connected to logical node 5. In step 106, prior to data acquisition, each logical node n is addressed and commanded to set the connected tracker to angle Θn taking care that adjacent trackers and controllers are not set to the same angle:

$$\left(θ \text{n+1 !=} θ \text{n !=} θ \text{n-1}\right)$$

The number of unique angles is chosen such that all individual trackers in a single row of trackers are set to different angles UAV Image acquisition: post initial setup, a UAV is flown over the row/rows of trackers that are to be mapped. In step 108, the UAV is flown either manually, or in an autonomous mode of operation. The UAV is set to capture orthogonal images of the area of interest, ensuring sufficient overlap for image stitching and photogrammetric 3D reconstruction.

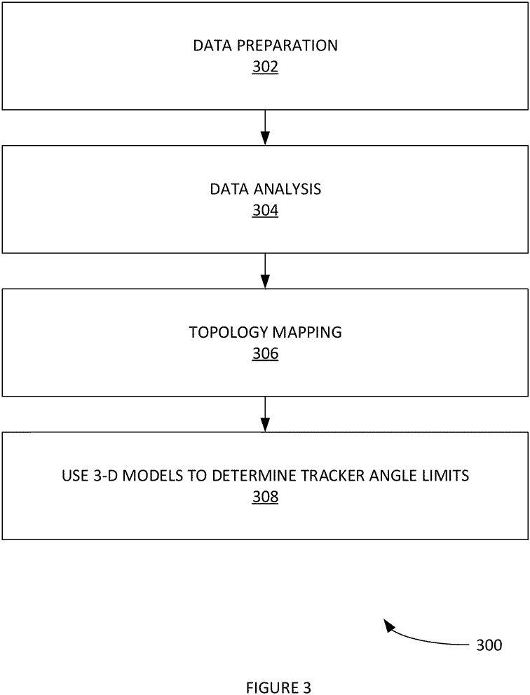

FIG. 3 illustrates an example process 300 for mapping-related data processing, according to some embodiments. In step 302, data is prepared. The acquired images are processed to develop a 3D model and an orthogonal image of the of the target area. The orthogonal contains a to-scale 2D view of the area of interest as viewed from 90 degrees over the area.

In step 304, data is analyzed. The orthogonal image of the tracker row/trackers is processed to extract orthographic images individual trackers. These images correspond to the projection of the tracker surface on a plane perpendicular to the vertical.

The width of the bounding box (e.g. the projected width of the tracker surface) is determined algorithmically and stored. With prior knowledge of the actual width of each tracker/PV modules, process 300 can calculate the angle of inclination of the tracker based on a specified geometric relationship. For example, the projected width of the tracker surface of physical tracker x (Wax) is given by cos Θx x Actual width Wx. Thus Θx = Cos-1( Wax/Wx).

In step 306, process 300 can implement topology mapping. The list of physical tracker angles Θx is compared with the list of set tracker angles Θn to identify one-one connections between logical control nodes n with physical tracker instances x. This can enable the mapping of the physical topology.

In step 308, process 300 can use 3D models to determine tracker angle limits. Process 300 can use the orthogonal image to determine tracker angle limits the total number of unique angles used due to the symmetry between inclination to the west and the east. The projected width can be equal for trackers tilted by Θn to the west and -Θn to the east. To enable differentiating between trackers tilted by the same angle, but in opposite directions, the 3D model and/or the digital surface model is used to determine direction of tilt, thus differentiating between trackers tilted to either side, but at the same angle. This can increase the number of individual tracker driver mappings that can be completed in a single flight. Process 100 and 300 can be combined in whole and/or in part.

### Mission Planning While Ensuring Adequate Coverage of Target Area During UAV Image Acquisition

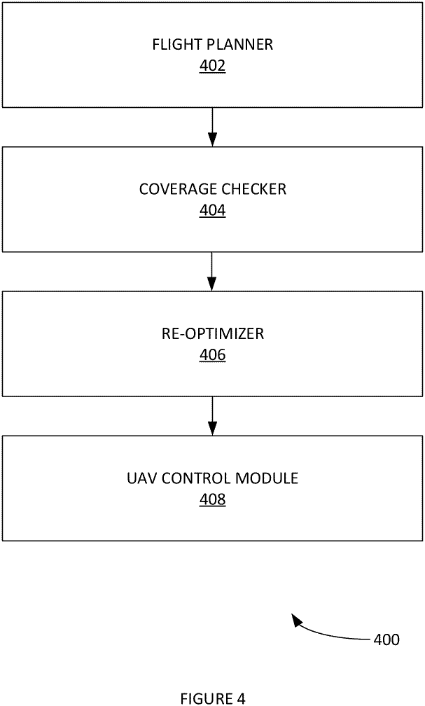

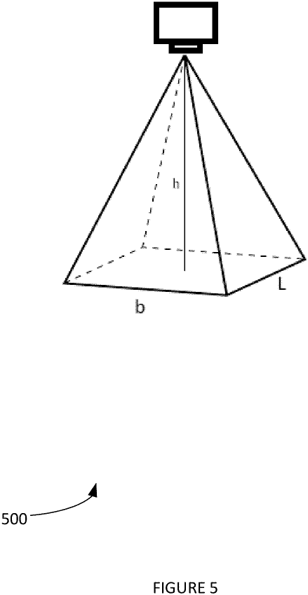

FIG. 4 illustrates an example system 400 for implementing mission planning while ensuring adequate coverage of target area during UAV image acquisition, according to some embodiments. System 400 is flight planning and UAV control system that automatically checks for adequate coverage of the angle of incidence (AOI) with the planned flight path. This can be performed before conducting the flight mission. System 400 includes methods to automatically add flight path extensions to cover the areas not sufficiently covered by the initial mission.

Flight planner module 402 obtains the following information from the user and/or from pre-set data sources. Flight planner module 402 obtains the Ground Sampling Distance (GSD). This is used for special resolution of the digital image. Flight planner module 402 obtains camera resolution of the camera attached to the UAV. Flight planner module 402 obtains the IW (image resolution width). Flight planner module 402 obtains IH (image resolution height). Flight planner module 402 obtains/determines the Side overlap(SO) use for each image to match with the other adjacent image to the sides of the direction of UAV. Flight planner module 402 obtains/determines the Front overlap(FO) required for each image to match with the other adjacent image to the front of the direction of UAV. Flight planner module 402 obtains/determines the Polygon representing the target survey area. Flight planner module 402 obtains/determines coverage factor. Flight planner module 402 obtains/determines a minimum number of images obtained from distinct locations that every point in the AOI should be present in. Flight planner 402 then determines an optimal flight route for the data collection process and also determines locations from which images are obtained.

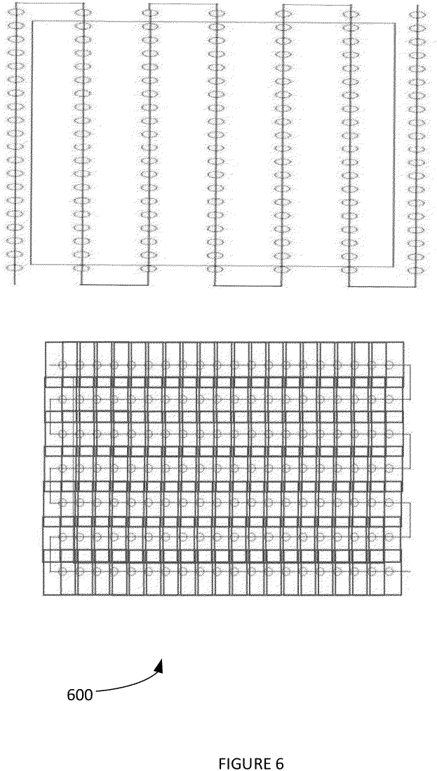

Coverage checker module 404 is built based on an understanding of camera physics. Coverage checker module 404 obtains the list of locations from which images are obtained and a polygon describing the area of interest from Flight Planner module 402. From image locations obtained, polygons are projected to represent the area on the ground covered by an image obtained from the specific location. Projected polygons are stored in a list. FIG. 5 illustrates an example polygon 500 with breadth b and length I can be projected for a known camera at a known height, according to some embodiments. FIG. 6 illustrates an example view 600 of a Planned mission and projected polygons on the ground, according to some embodiments.

The AOI polygon is then filled with a point grid representing infinitely small points within the polygon. For example, grid spacing can be equated to ground sampling distance for optimal results. Identified individual points are stored in a list. Each grid point is determined. Each grid point is then checked against the list of polygons to check for coverage. The number of polygons containing each grid point is thus determined. If the number of polygons is lower than the defined coverage factor, the point is then moved to a list of low coverage points.

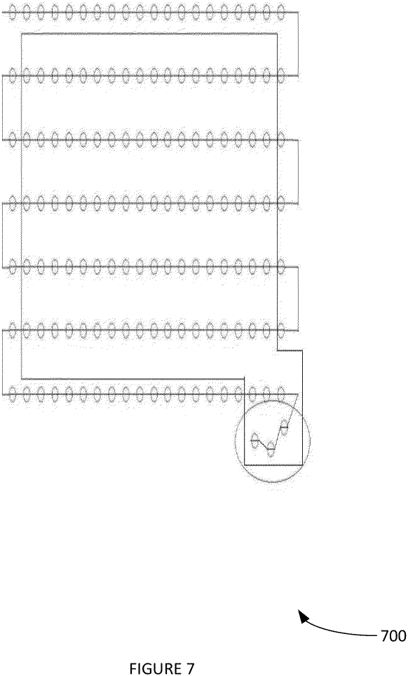

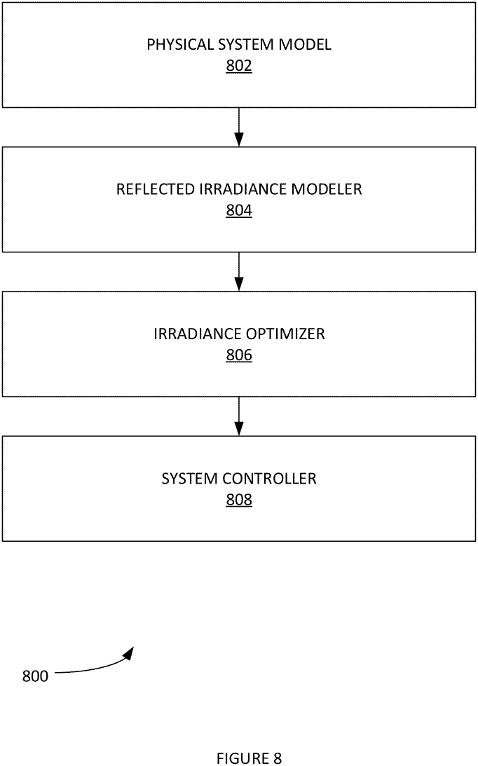

Re-optimizer module 406 obtains the list of low coverage points from the coverage checker and the flight plan from flight planner module 402. In order to cover the low coverage points adequately, re-optimizer module 406 creates additional flight paths covering the list of low coverage points and appends the paths thus generated, to the flight plan. FIG. 7 illustrates an additional path for low coverage areas (circled in red), according to some embodiments.

The output of the re-optimizer module is transferred to a UAV in the form of geolocated way points by the flight control module 408. Flight control module 408 also provides for a user to initiate and monitor the actual flight path.

### Enhanced Energy Production (Yield) From Generating Plants With Bifacial Solar PV Modules Using Unmanned Aerial Vehicles

FIG. 8 illustrates an example process 800 for enhanced energy production (yield) from generating plants with bifacial solar PV modules using unmanned aerial vehicles, according to some embodiments. Process 800 can be used to enhance energy yield from bi-facial solar PV based generating systems. Bifacial modules expose both the front and back of the solar cells that make up a PV module. Bifacial modules are installed on a reflective surface, and systems can provide an increase in production. Bifacial modules can be combined with tracker systems to increase yield.

More specifically, in step 802, process 800 can implement a Physical System Model (PSM). The PSM is a digital model of the constructed solar PV generating plant. The physical model is created by a PSM generator using data from an unmanned aerial vehicle (UAV) or Drone that is flown over the plant. The PSM generator is a software tool that is either hosted on the cloud or made available as a stand-alone implementation. A single solar generating plant is uniquely identified by the modeler using global location information and a geographical boundary defining the extent of the identified PV plant. To initiate modelling, the PSM generator obtains plant location and boundary information from the user and creates UAV flight plans that can be used to collect required data by flying a UAV within the geographic boundary. Flight planning and control software modules are then used to fly UAVs in the planned areas and obtain data. Single and/or multiple flights can be performed over the solar plant to obtain overlapping visual images and multi-spectral images of the underlying terrain and collector surfaces (e.g. surface of the PV modules).

In one example, these flights are conducted with the position of the trackers fixed to a specified angle. Multi-spectral images may be obtained multiple times, with the trackers fixed to different angles. This can enable accurate albedo modelling of the ground underneath the modules. The obtained data is then processed to generate two (2) models: a. 3D plant model and b. a ground albedo model.

The 3D plant model is created using overlapping images of the plant. The images are processed using photogrammetry to obtain an accurate 3D model of the entire plant region. The generated model is then processed to identify individual trackers and build a collector surface model (CSM) and a ground surface model (GSM). The identified trackers are automatically numbered to uniquely identify each tracker row and to map the physical model to an electrical control model of the plant. The model includes accurate position information (x, y, z) of the tracker surface with respect to a global reference point.

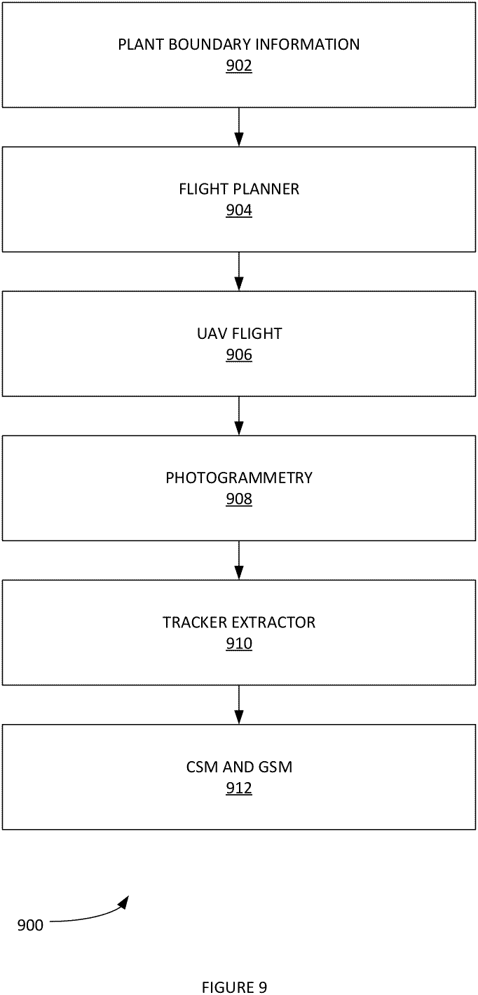

FIG. 9 illustrates an example process for implementing a PSM, according to some embodiments. In step 902, process 900 can calculate plant boundary information. In step 904, process 900 can implement a flight planner. In step 906, process can implement a UAV flight. In step 908, process 900 can implement photogrammetry on data obtained from the UAV flight. In step 910, process 900 can provide/implement a tracker extractor. In step 912, process 900 can model the CSM and GSM.

Returning to process 800, in step 804, process 800 can implement the reflected Irradiance modeler (RIM). The RIM uses the generated ground albedo and the GSM to model reflected irradiance on the collector surface at any instant in time. The reflected irradiance on the collector surface is a function of solar angle. This can also be a function of the contributing ground surface, albedo, and tracker angle.

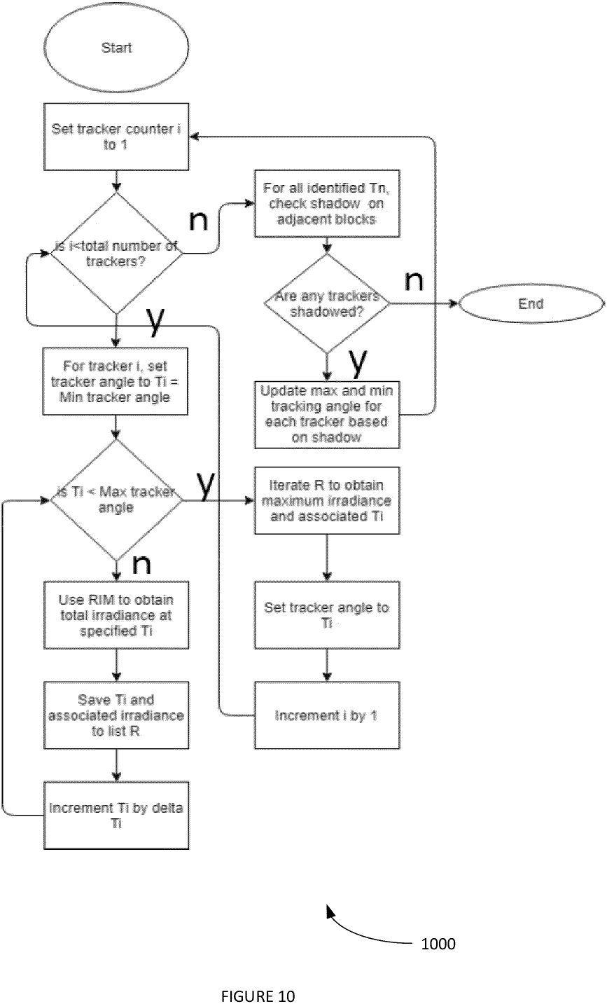

In step 806, process 800 can implement an irradiance optimizer. The irradiance optimizer estimates total incident irradiation (e.g. based on reflected on the back plus incident on the surface) using data from the RIM. This can be done for all allowable tracker angles and identifies tracker angle for maximum irradiance and thus maximum energy yield. Step 806 can be initially performed for each individual tracker. Once the ideal position for all individual trackers is estimated, the irradiance optimizer then performs a shadow analysis for the entire block (and/or plant) with individual trackers set to identified angles. Process 800 can identify inter-tracker shadows. On identification of rows that suffer from shadow, the irradiance optimizer then applies boundary conditions on the tracker angle. This can be done to avoid shadows. This can also reoptimize the individual trackers and/or sets of trackers for maximum irradiance collection without shadow affects. FIG. 10 illustrates an example irradiance-optimizer process 1000, according to some embodiments.

In step 808, process 800 is the system controller. The system controller queries the irradiance optimizer of step 806 to obtain tracker angles for each tracker in the plant. The obtained tracker angles are then transmitted to the corresponding actuators in the PV system to set tracker angle.

### Development of a Vectorized 3D As-Built Model for a PV Plant

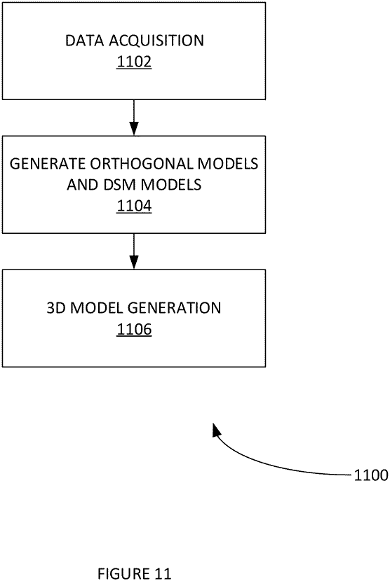

FIG. 11 illustrates an example process 1100 for developing a vectorized 3D as-built model for a PV plant, according to some embodiments. Process 1100 can be used to develop the vectorized 3D as-built model for a Photovoltaic plant using visual imagery obtained by unmanned aerial vehicles (UAV). Process 1100 enable the geographical assessment of table design and terrain of the land where these array of PV modules are installed.

In step 1102, process 1100 can implement data acquisition. The data is collected using UAV by mounting a visual camera on to the vehicle and it is flown according to the flight path and the images are taken at a predetermined interval.

In step 1104, process 1100 can generate orthogonal model(s) and DSM model(s). The images obtained from the UAV are fed into a photogrammetric software. The photogrammetric software uses various algorithms for stereo calibration. The digital images are stitched, and an orthogonal mosaic is modelled. A region flown by the UAV is also modelled.

In step 1106, process 1000 can implement 3D model generation. As process 1100 obtains the orthogonal and DSM (and a various other user parameter to improve performance) it generates and outputs the corresponding 3D model.

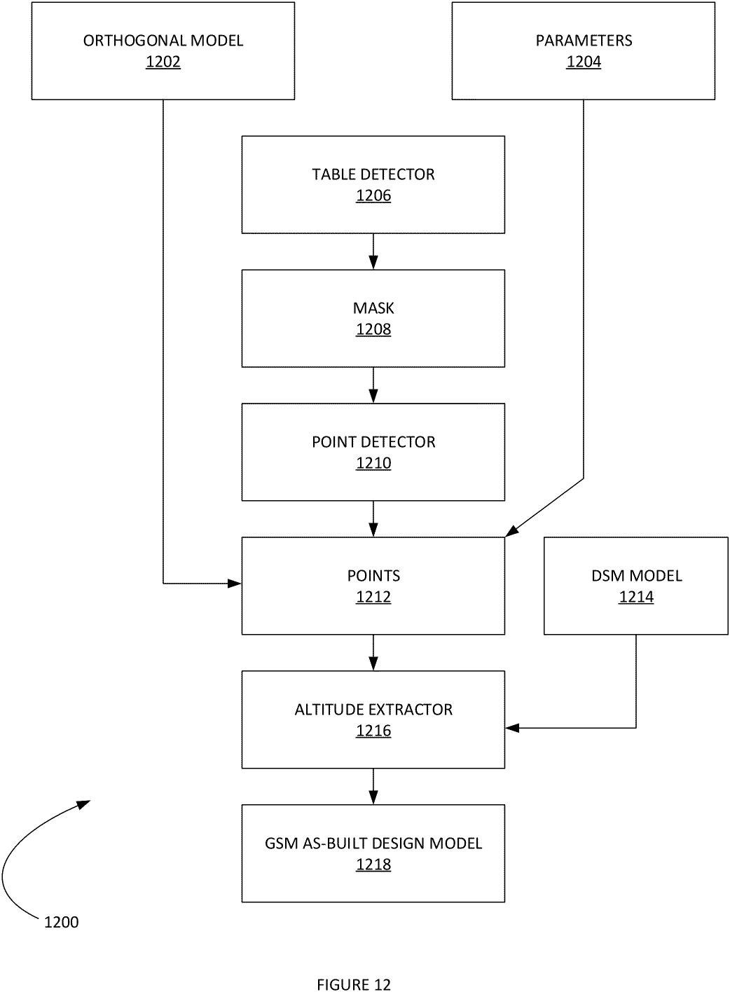

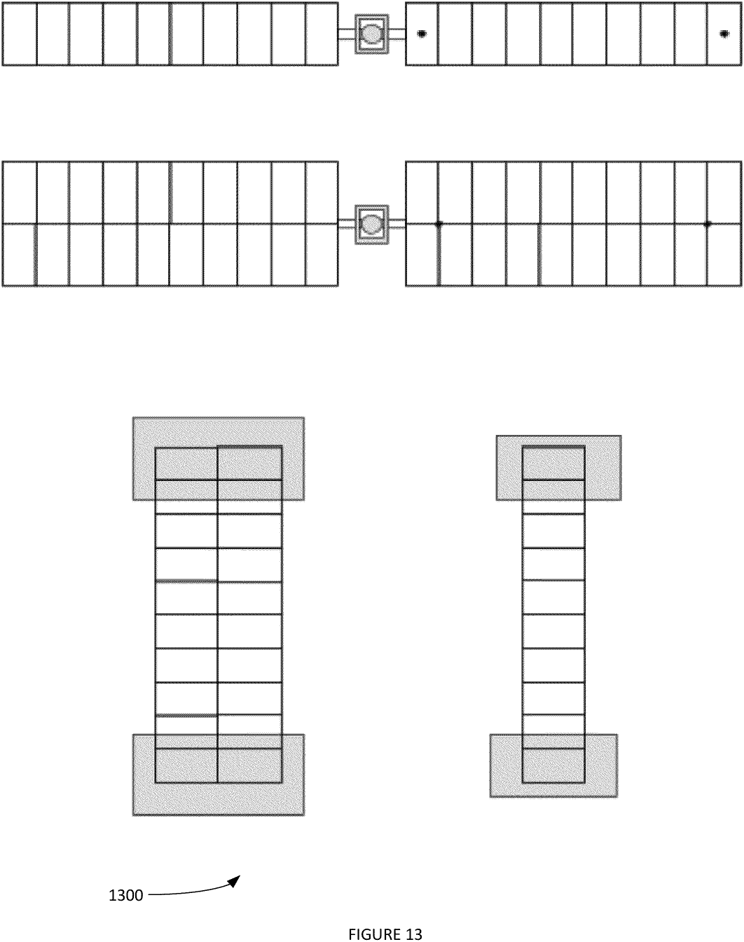

FIG. 12 illustrates an example process 1200 for processing pipeline for 3D model generation, according to some embodiments. In step 1202 and 1214, the Orthogonal and DSM models are provided. It is noted that the ortho-mosaic and DSM are generated by using a photogrammetric software. The photogrammetric software processes the raw images by extracting key points in each image and match them with other images. The photogrammetric software builds bundles of digital images and then stitches said digital images together. Since, the UAV is planned to move in a plane parallel to the ground, it acts as a stereo camera and therefore a depth map can be constructed from the neighboring images for a region.

In step 1204, process 1200 provides various parameters. The parameters are defined by the user to achieve better performance. Example parameters can include various information about distance from points and width of the tables for 3D model generation and several hyperparameters used for the training of deep learning models.

In step 1206, process 1200 implements a table detector. Solar panels are arranged in an array (e.g. strings). Strings can be grouped to form a table structure. In order to generate a 3D model, process 1200 can identify and segment the table boundaries. Process 1200 can use machine learning (e.g. deep learning methods, etc.) to segment the tables out from the ortho-mosaic. In step 1208, process 1200 can implement an image mask process.

In step 1210, process 1200 can implement point detector methods. Process 1200 can detect important point location in the segmented table regions for precise estimation of table geographic location. The definition of points may vary according to the type of solar plant. For example, in case of a tracker plant where an array of N solar PV modules are arranged as Nx1. Process 1200 can use two points for each table such that one point is the center of topmost module and the other is for bottom. In case of more than one module, process 1200 can locate the center along the line separating the modules.

FIG. 13 illustrates example views of point detectors, according to some embodiments. As shown in the example of FIG. 13, on the left side, there are two types of tables with trackers. The points of interest are marked on the top tables for identification in step 1212. This can be done for non-tracker plants except (e.g. with no tracker). FIG. 13 illustrates shows a tracker table example. As shown, the points of interest are different, a user parameter for height of ROI can be used. On the right side, FIG. 13 shows the ROI in gray color. Process 1200 can determine the width of the table, as well as the height to be used with a point detection module/process. This parameter can be defined by the user.

In step 1214, process 1200 can implement an altitude extractor. Process 1200 can obtain extreme points of a table. Process 12000 can fetch the altitudes at these points from DSM and extend the point by a specified distance. The specified distance can be a parameter defined by the user so as to make the points be on exact edge of the table.

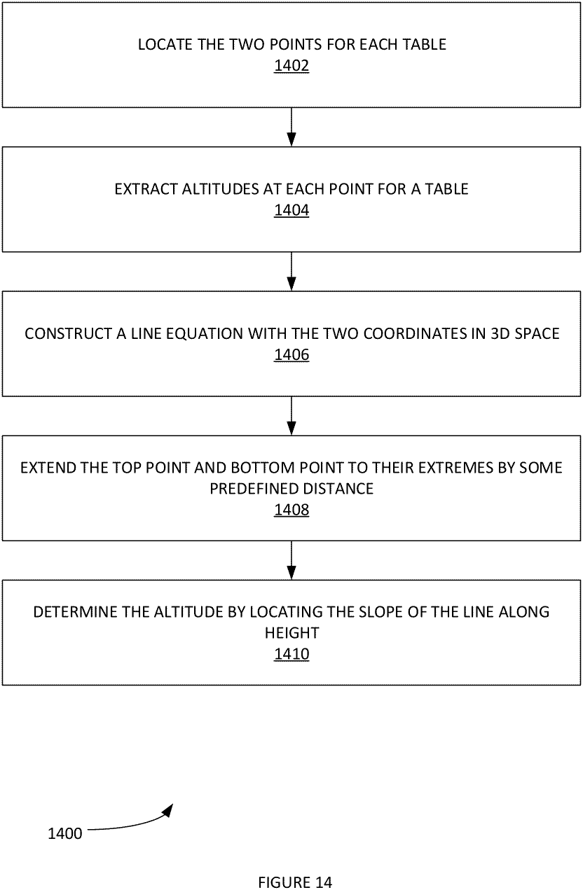

FIG. 14 illustrates an example process for implementing an altitude extractor, according to some embodiments. In step 1402, process 1400 locates the two points for each table. In step 1404, process 1400 extracts altitudes at each point for a table. In step 1406, process 1400 constructs a line equation with the two coordinates in 3D space. In step 1408, process 1400 extends the top point and bottom point to their extremes by some predefined distance. In step 1410, process 1400 determines the altitude by locating the slope of the line along height. It is noted that process 1400 can use an as-built design, and, accordingly, need not always use the DSM altitudes.

For example, process 1400 can use a RANSAC algorithm over the collected data. The RANSAC algorithm can utilized the fact that the likelihood of hitting a good configuration by randomly selecting a small set of observations is large. It is noted that the number of necessary trials does not depend on the number of observations N (e.g. for a relatively large N, etc.).

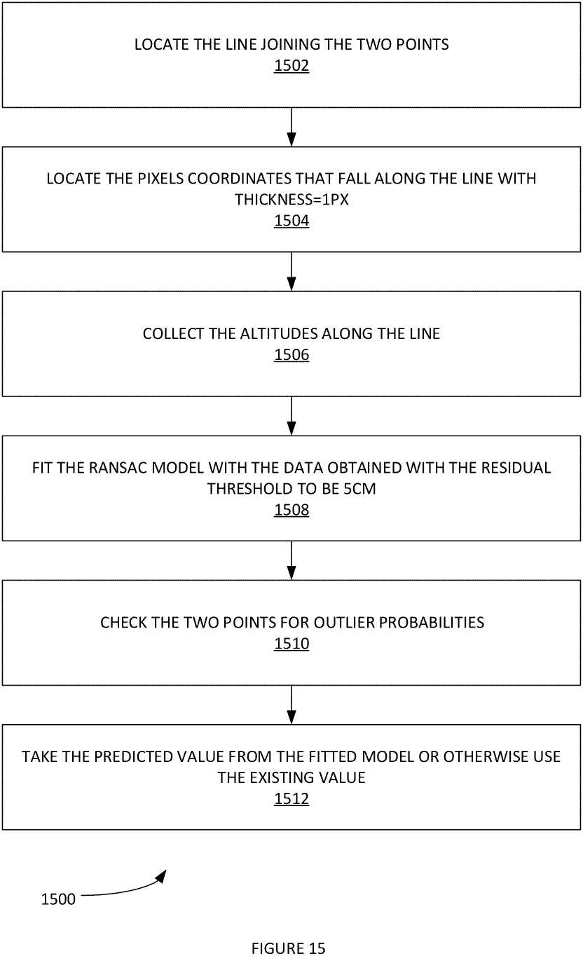

FIG. 15 illustrates an example process 1500 for implementing a RANSAC algorithm on each table, according to some embodiments. Process 1500 can implement the RANSAC algorithm for each table. In step 1502, process 1500 can locate the line joining the two points (e.g. before extending). In step 1504, process 1500 can locate the pixels coordinates that fall along the line with thickness=1px. In step 1506, process 1500 can collect the altitudes along the line. In step 1508, process 1500 can fit the RANSAC model with the data obtained with the residual threshold to be 5 cm. In step 1510, can check the two points for outlier probabilities. In step 1512, if outliers are detected, then process 1500 can take the predicted value from the fitted model or otherwise use the existing value. In this way, by fitting a RANSAC regressor for the table points, process 1500 is able to determine the accurate altitudes and then proceed to extend them as explained above. Additionally, for even more accurate predictions, process 1500 can take into account the inter table points to determine any outliers in altitudes. Process 1500 can sort the tables in 2D space. This can be done in left-right and top-bottom manner. For any given point in a table, process 1500 can fetch the tables within the same row and then apply RANSAC again to check for outliers and continue the process as explained above.

Returning to process 1200, in step 1218, process 1200 can provide a 3D as-built design model. Process 1200 determines the x, y, z values for both extremes of a table. This can be done with the help of user defined parameters such as, inter alia: width, etc. Process 1200 can generate a 3D model out of it. Also, process 1200 can arrange the points in a hierarchy. Process 1200 can also debug and implement quality checks prior to outputting final result.

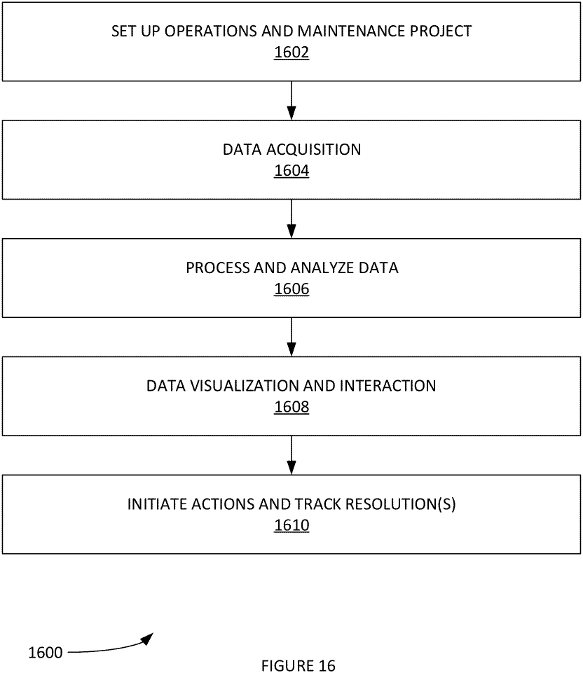

FIG. 16 illustrates an example process for operations and maintenance of a photovoltaics system, according to some embodiments. Process 1600 can enable a user to setup project to create a digital twin of project on a core platform. Process 1600 can collect data through multiple modes. Process 1600 can enable the user to upload data onto the core platform. Project 1600 can then obtain various key metrics and display these on a dashboard view. Project 1600 can track operations and maintenance issues. With the automatic dashboard view, process 1600 can display the quality metrics. In this way, users can view an installation site and features. The view can provide measured values and detected issues (e.g. hotspots, bypass diode, short circuit, vegetation, dirt etc.). Process 1600 can process data, detect, and classify issues using an AI engine. Process 1600 can be used to initiate actions on installation site.

For example, more specifically, in step 1602, users can create and tag tickets, pictures to specific components, etc. Users can track and resolve these issues using an application mobile application (e.g. locate tickets, take actions, capture all data, digitally set up operations and maintenance project. In step 1604, process 1600 can implement data acquisition 1604. These can be from, inter alia: design documents, component level information, on-site inputs (e.g. via mobile device, etc.), drone images (e.g. visual, thermal, etc.).

In step 1606, process and analyze data. In step 1608, process 1600 can implement data visualization and interaction 1608. These can include, inter alia, site views, component views, geographical 3D views, dashboards (e.g. progress, inventory, quality, etc.), standard and custom reports, etc. In step 1610, process 1600 can initiate actions and track resolution(s) 1610. This can include, inter alia, enable the uploading/sharing of digital documents, enable problem solving (e.g. checklists, pictures Initiate quick site actions ,based on analysis, etc.).

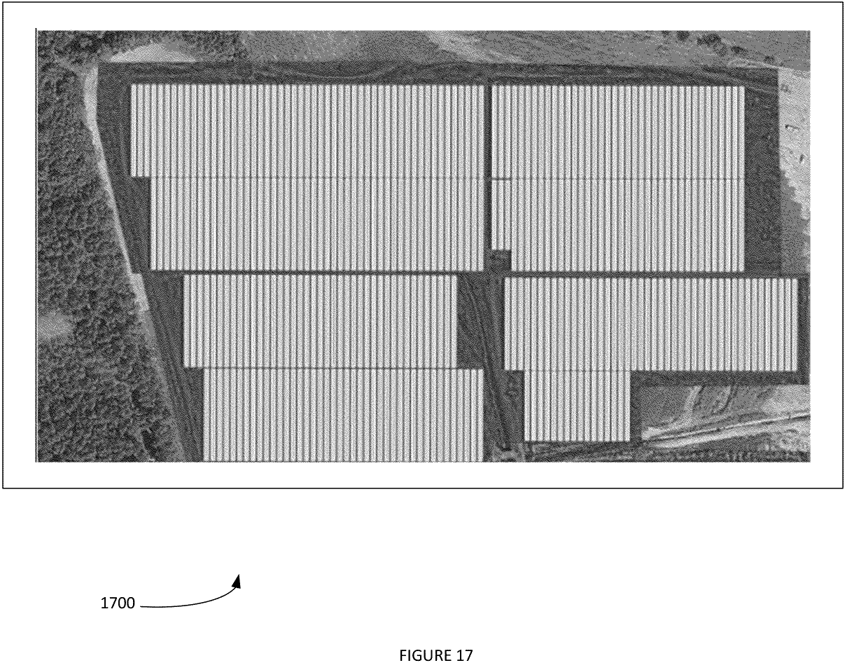

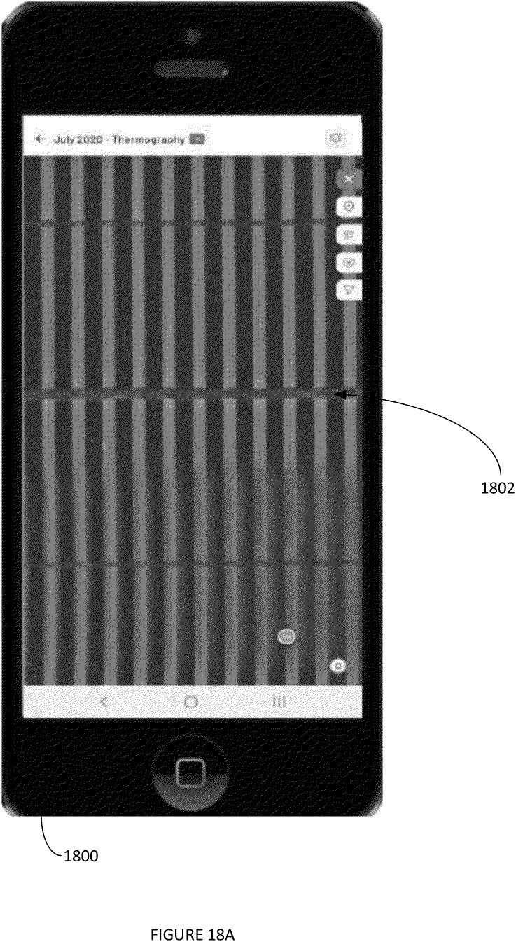

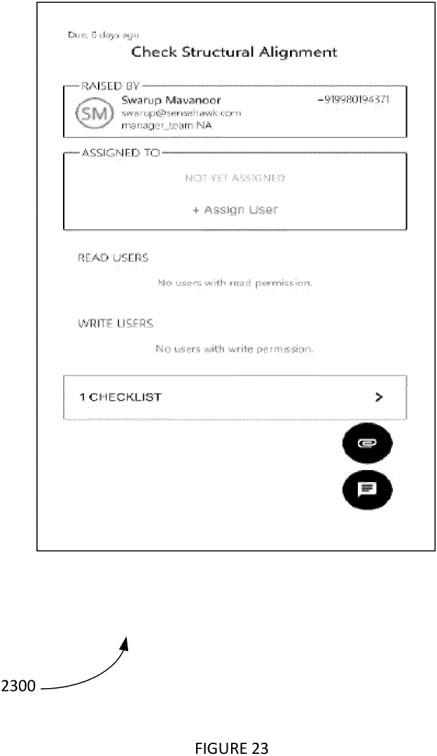

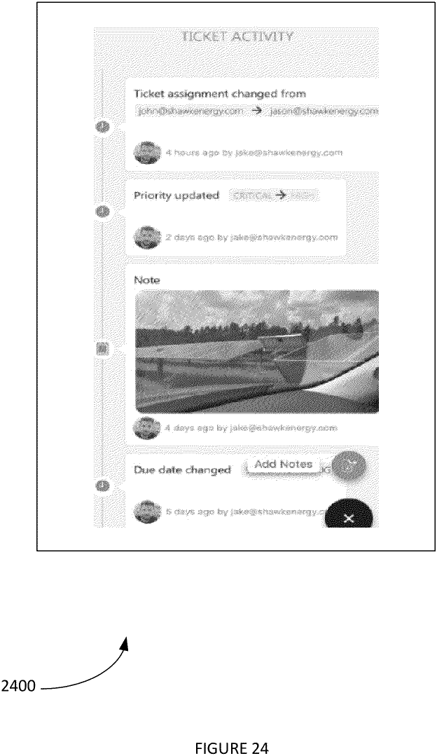

FIGS. 17-25 illustrate example operations and maintenance of a photovoltaics system interfaces 1700-2500, according to some embodiments. More specifically, FIG. 17 illustrates a display of a digital twin of a PV installation, according to some embodiments.

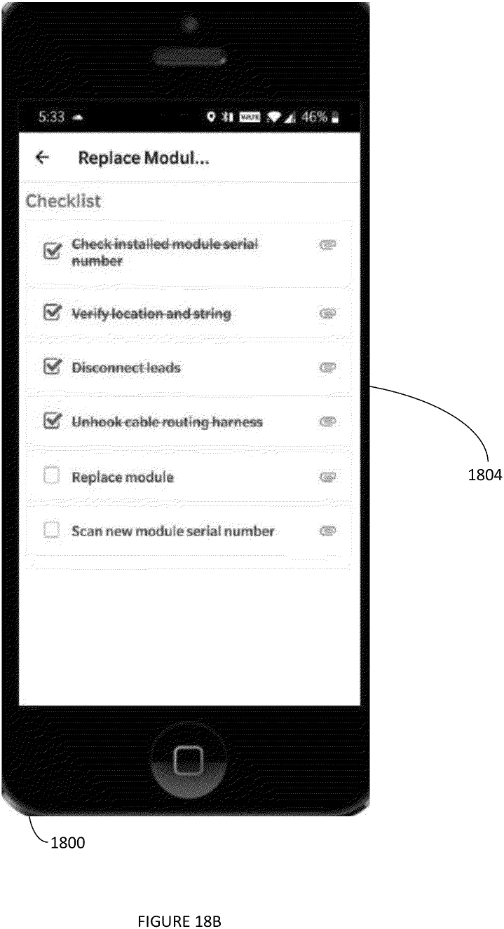

FIG. 18 A-B illustrates example mobile device application displays, according to some embodiments. A mobile application can display PV installation information. For example, FIG. 18A shows a thermography image 1802 of a PV installation. FIG. 18B shows the mobile application displaying . A user can walk the PV installation site and capture information tickets, checklists, etc. The mobile application can work in an offline mode (e.g. when no network is available) and data can be synchronized at a later time.

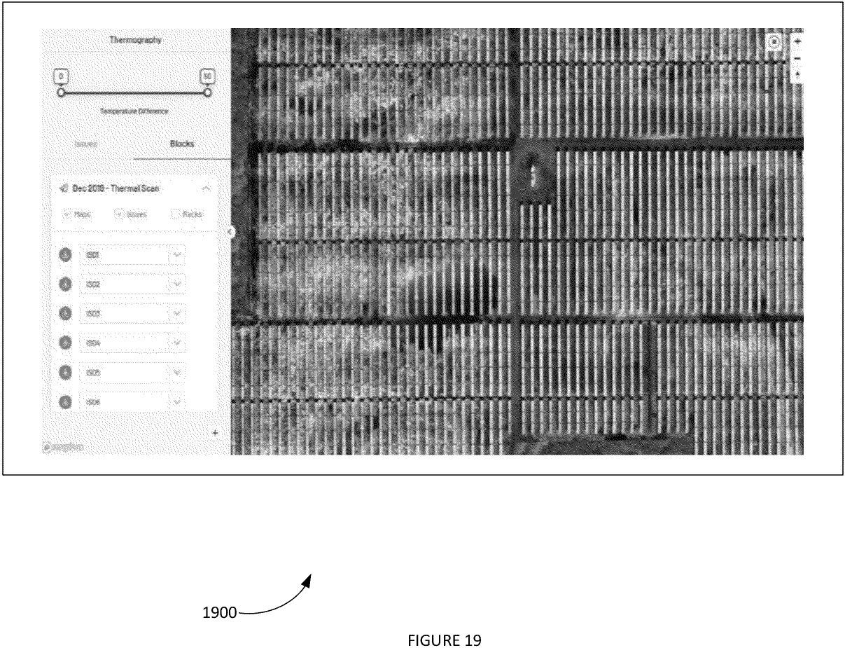

FIG. 19 illustrate a visualization of a site map, according to some embodiments. Work/order tickets can be created at a component level. Users/Administrators can collaborate through the desktop/mobile application.

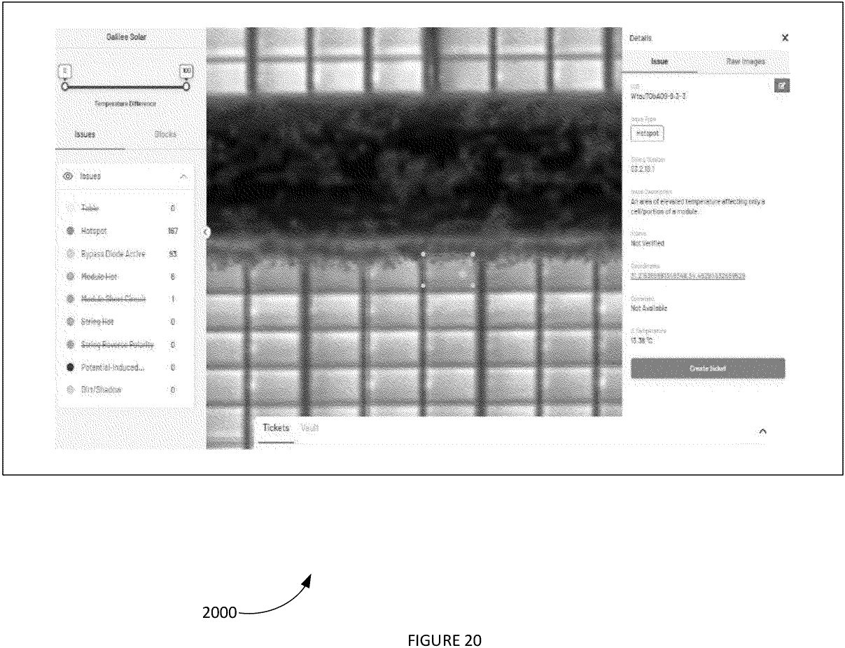

FIG. 20 illustrates an application view for visualizing the health of PV installation components, according to some embodiments. The PV installation application can automatically identify and detect component wise issues, detect hotspots, evaluate energy loss, track defects over time, etc.

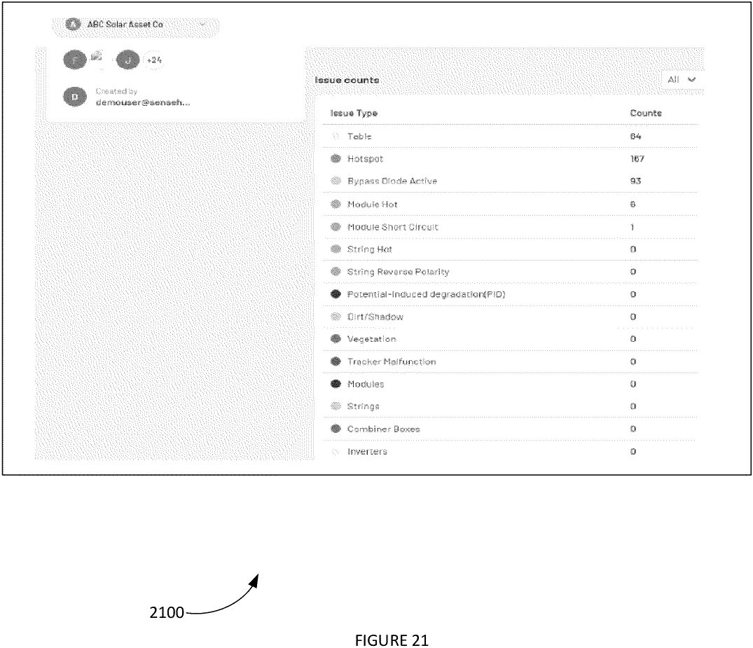

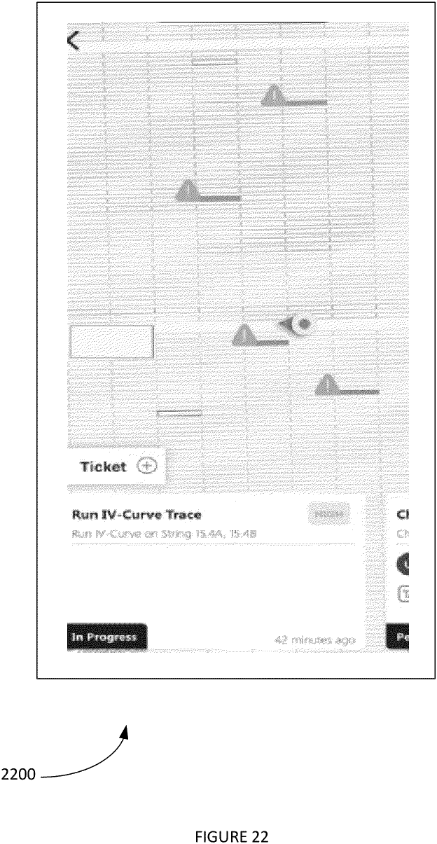

FIG. 21 illustrates an application view of an intuitive dashboards, according to some embodiments. FIGS. 22-24 illustrates another view of intuitive dashboards, , according to some embodiments. The dashboard(s) can be used to track component serial numbers, abstract data tracker, inverter, string, combiner box levels, etc.

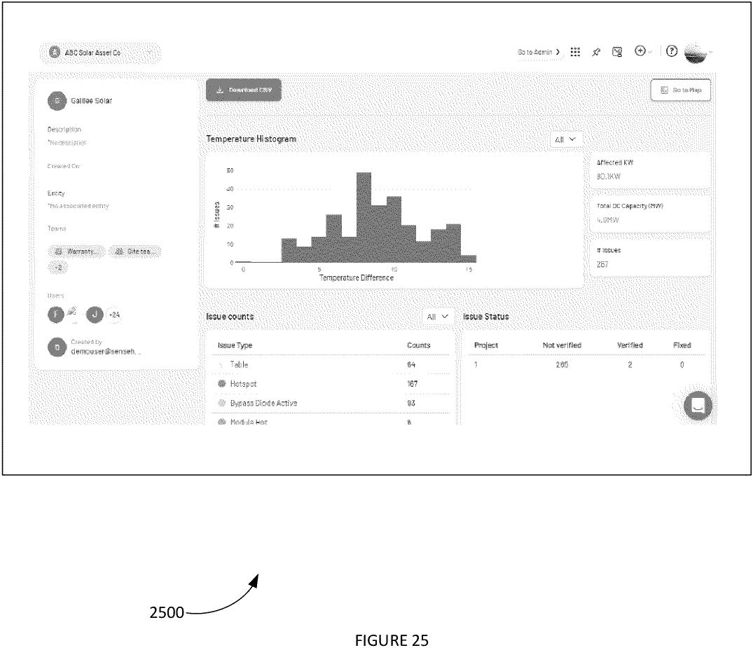

FIG. 25 illustrates another example screenshot 2500 of dashboard view of digitalized PV installation information, according to some embodiments. Screenshot 2500 shows example summary dashboards. The summary dashboards enable a user to review PV installation site and section status.

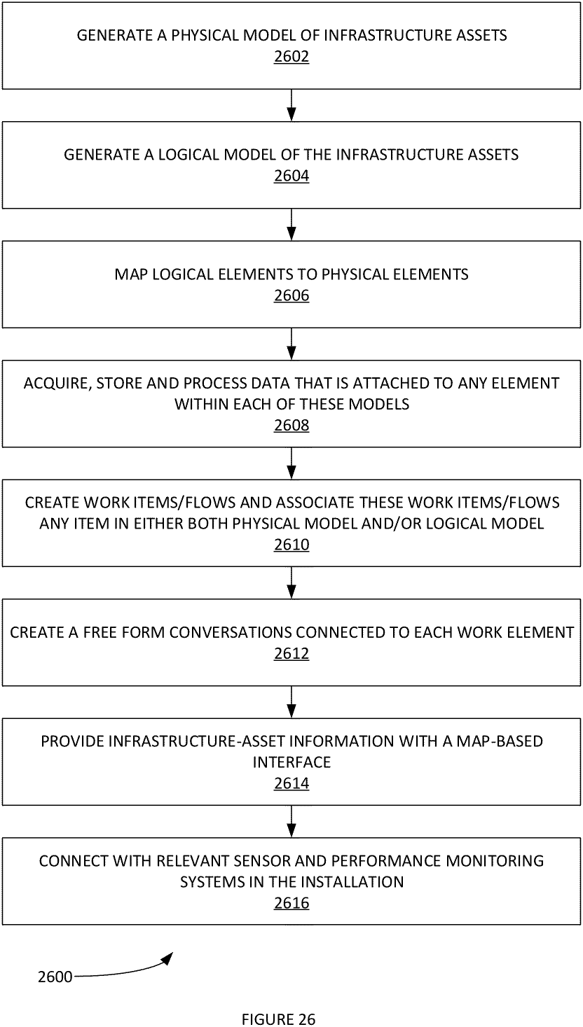

FIG. 26 illustrates an example process 2600 for digitizing a physical assets, according to some embodiments. In one example, as provided in FIGS. 18-25, the physical of assets can be a PV installation. In step 2602, process 2600 can generate a physical model of the infrastructure assets. The physical model of the vectors representing individual elements within the asset. Each element has a location and a specific set of properties (e.g. title of element, subcomponents, etc.) can be used to generate a hyperlink to the object.

In step 2604, process 2600 can generate a logical model of the infrastructure assets. The logical model can describe how each object in physical model are connected to each other, can also go into sub-component level (e.g. with a tracker with strings, etc.).

In step 2606, process 2600 can map logical elements to physical elements. This can be done in a many to one set of relationships.

In step 2608, process 2600 can acquire, store and process data that is attached to any element within each of these models. Process 2600 can use various data types (e.g. files, time series data, processing information, agreements, component data sheets, warranty docs, legal docs, etc.). These all attached to the element. Returning to the PV installation example, it is noted that a component may not be restricted to physical but can include documentation of land the PV installation sits on, documentation about the PV structure(s), etc. In this way, process 2600 can collect and attach the available data to the elements.

In step 2610, process 2600 can create work items/flows and associate these work items/flows any item in either both physical model and/or logical model. A workflow can be in form of single task, group of tasks, workflow, etc. To each work element, process 2600 can assign an entity be responsible, manage, etc. Process 2600 can also attach files, diagrams, documents, images, etc. to the workflow.

In step 2612, process 2600 can create a free form conversations connected to each work element. These can be managed via various electronic communication systems (e.g. IMS, SMS, MMS, e-mail, etc.). Again, these conversations can be attached to any element in physical model and/or logical model of the infrastructure asset(s) and/or any other object in the system (e.g. can create work element against a document, need to renew a contract every year, etc.).

It is noted that each work element is cross reference to elements in other available physical model(s) and/or logical model(s) of the infrastructure assets (e.g. attach to logical mod component is also attached to physical component, etc.).

In step 2614, process 2600 can provide infrastructure-asset information with a map-based interface. The map-based interface can be viewed/accessed via any type of computing device (e.g. personal computer, mobile devices such as smart phones, tablet computers, etc.). The map-based interface can display and enable navigation on interface to enable a user to locate a component against which a work element has been created. The user can then view all the information about the work element and the component.

In step 2616, process 2600 can connect with relevant sensor and performance monitoring systems in the installation. Process 2600 can then connect sensor and performance monitoring systems data (e.g. sensor and performance data) to the relevant components of the physical and logical models.

Process 2600 can create views of any element or group of elements/components and combine with any data associated with them. These views can be exported (e.g. containerized and passed on to another system). FIGS. 18-25 supra provide examples of the steps of process 2600 applied to a PV installation.

Furthermore, it is noted that in some embodiments, also, each logical element may be mapped to a physical element, but this is not strictly necessary (e.g. a logical element can exist without being connected). Data can be attached to a logical model element or a physical model element. When connected, the data is associated with both. The workflow is associated (with or to and not at ) an element of the physical or logical model. Additionally, it is noted that an automated method can be provided to traverse the logical and physical model to find related elements and associate actions with related elements based on an action related to one or more elements in the model.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method of useful for digitizing a physical of assets comprising:
with a processor of a mobile device,
obtaining a set of information from an infrastructure of assets;
from the set of information,
generating a physical model of the infrastructure of assets, wherein the physical model comprises a set of the vectors representing each of the individual physical elements within each asset;
generating a logical model of the infrastructure of assets, wherein the logical model comprises of connections between elements in the physical model or a connection between an element in the physical model to an element in the logical model or connections between two logical elements;
mapping each element of the logical model to at least one element of the physical model;
acquiring and attaching data to an element of the logical model to an element of the physical model;
creating a workflow and associating the workflow at least one element of the physical model or the logical model;
providing an infrastructure-asset information with a map-based interface, wherein the infrastructure-asset information comprises information about each asset of the infrastructure of assets; and
creating a set of views, wherein the set of views is combined with any data associated with a relevant element of the physical model or logical model, and wherein the set of views is viewable via a computerized dashboard application.

2. The computer-implemented method of claim 1, wherein the physical of assets comprises a photo-voltaic installation.

3. The computer-implemented method of claim 2, wherein each element comprises a specific set of properties.

4. The computer-implemented method of claim 3, wherein the specific set of properties comprises an element location value.

5. The computer-implemented method of claim 4, wherein the specific set of properties comprises a title of the element and list of subcomponents of the element.

6. The computer-implemented method of claim 5, wherein the specific set of properties are used to generate a hyperlink to the object.

7. The computer-implemented method of claim 6, wherein the logical model further comprises a sub-component level.

8. The computer-implemented method of claim 7, wherein the attached data comprises a data types comprises a set of time series data, a processing information, a digitized version an agreement, a digitized component of a data sheet, a digitized warranty documents, a digitized legal document.

9. The computerized method of claim 1 further comprising:
creating a digital conversation functionality connected to each work element.

10. The computerized method of claim 1 further comprising:
connecting a sensor and performance monitoring systems in the installation of assets; and
integrating a sensor and a performance data from the sensor and performance monitoring systems into the infrastructure-asset information with a map-based interface.

11. The computerized method of claim 1 further comprising:
implementing an altitude extractor by:
obtaining a set of extreme points of a table;
fetching a set of altitudes at the set of extreme points from a Digital surface model (DSM); and
extending the set of extreme points by a specified distance, wherein the specified distance comprises a parameter defined by a user so as to make the set of extreme points be on an exact edge of the table.

12. The computerized method of claim 1 further comprising:
using a set of one or more 3D models of a portion of the physical of assets to determine an optimum tracker angle.

13. The computerized method of claim 1 further comprising:
providing an automated method to traverse the logical and physical model to find related elements and associate actions with related elements based on an action related to one or more elements in the model.

14. A computerized system useful for digitizing a physical of assets, comprising:
at least one processor configured to execute instructions;
a memory containing instructions when executed on the processor, causes the at least one processor to perform operations that:
obtaining a set of information from an infrastructure of assets;
from the set of information,
generate a physical model of the infrastructure of assets, wherein the physical model comprises a set of the vectors representing each of the individual physical elements within each asset;
generate a logical model of the infrastructure of assets, wherein the logical model comprises a description of a connection between an element in the physical model to each other object of the physical model;
map each element of the logical model to at least one element of the physical model;
acquire and attaching data to an element of the logical model to an element of the physical model;
create a workflow and associating the workflow at least one element of the physical model or the logical model;
provide an infrastructure-asset information with a map-based interface, wherein the infrastructure-asset information comprises information about each asset of the infrastructure of assets; and
create a set of views, wherein the set of views is combined with any data associated with a relevant element of the physical model or logical model, and wherein the set of views is viewable via a computerized dashboard application.
